(19) United States
(12) Patent Application Publication
(10) Pub. No.: US 2025/0026116 A1
(43) Pub. Date: Jan. 23, 2025

(54) RECYCLED PET CONSTRUCTION PANELS AND METHODS OF MANUFACTURING STRUCTURES USING THE PANELS

(71) Applicant: Acadian Composite Materials, Inc., Woolwich, ME (US)

(72) Inventors: Benjamin Thomas Davis, Freeport, ME (US); Gerald Fortier, Nottingham, NH (US); John Rossi, Newburyport, MA (US); Michael Sullivan, Rye, NH (US)

(21) Appl. No.: 18/776,554

(22) Filed: Jul. 18, 2024

Related U.S. Application Data
(60) Provisional application No. 63/527,468, filed on Jul. 18, 2023.

(51) Int. Cl. B32B 27/12; B32B 5/12; B32B 27/36; B63B 3/68; E04C 2/22

(52) U.S. Cl. CPC B32B 27/12; B32B 5/12; B32B 27/36; B63B 3/68; E04C 2/22; B32B 2260/023; B32B 2260/046; B32B 2272/00; B32B 2607/00

(57) ABSTRACT

A system and method for building and assembling parts of or entire modular structures such as dwelling units, marine structures or watercraft from recycled PET material panels. Each assembly is made from panels of recycled PET material having a core and a rigid skin on both faces of the panel. The panels are joined together with splines of the same type of panel material. The splines may be glued and or fastened in place. The panels provide the necessary rigidity and insulative qualities for construction and watercraft manufacture and may be painted. The panels are impervious to environmental elements as well as to insects.

### TECHNICAL FIELD

The present disclosure relates generally to a recycled PET plastic construction panel and a method of constructing a structure utilizing the recycled PET panels.

### BACKGROUND INFORMATION

Modular building manufacturing describes the process of producing individual section or modules that will be assembled into a finished building at a final site. Such buildings have become valuable to a variety of industries including residential, commercial, corrections, education, healthcare, utilities, government and more.

Typical modular construction is performed in a factory where structural elements (such as wall studs, floor or ceilings joists and plywood or similar sheathing) are assembled into either prefabricated wall, floor, ceiling/roof panels and shipped to an assembly site for final assembly. In other modular construction methods, an entire structure (or part of a finished structure) is constructed in a factory and shipped for final assembly onsite.

Such prior art techniques rely on utilizing conventional construction materials which are typically expensive, time consuming to assemble, and difficult and costly to ship to the final assembly point/destination, and while awaiting or during initial assembly, are subject to damage by the elements including rain, snow, insects, and the like. In addition, the traditional construction materials such as wood or aluminum are not environmentally friendly.

Accordingly, what is needed is a construction panel material which is lightweight, environmentally friendly, and preferably made of recycled materials, provides support for a structure, and are impervious to the elements.

### SUMMARY

The present invention features a recycled construction panel and methods for utilizing and assembling such recycled construction panels for residential, commercial, and other structures as well as for marine uses, including maritime structures and commercial & recreational watercraft.

It is important to note that the present invention is not intended to be limited to a system or method which must satisfy one or more of any stated objects or features of the invention. It is also important to note that the present invention is not limited to the preferred, exemplary, or primary embodiment(s) described herein.

Modifications and substitutions by one of ordinary skill in the art are considered to be within the scope of the present invention, which is not to be limited except by the allowed claims and their legal equivalents.

### BRIEF DESCRIPTION OF THE DRAWINGS

These and other features and advantages of the present invention will be better understood by reading the following detailed description, taken together with the drawings wherein:

FIG. 1 is a cross-sectional view of a PET panel according to one feature of the present invention;

FIG. 2 is a cross-sectional view of a multi-layer PET panel skin according to one feature of the present invention;

FIG. 3A is enlarged cross-sectional views of several layers of the PET panel skin showing reinforcement fiber strands in a horizontal orientation;

FIG. 3B is an enlarged cross-sectional view of several layers of the PET panel skin showing reinforcement fiber strands in a vertical orientation;

FIG. 4 is a perspective view of a floor panel assembly according to one feature of the invention;

FIG. 5 is a perspective view of a structure floor, and two wall assemblies according to a feature of the invention;

FIG. 6A is a perspective view of a structure during an assembly process involving a kitchen and bath module installation according to one feature of the present invention;

FIG. 6B is a perspective view of a structure after the assembly process shown in FIG. 6A;

FIG. 7 is a perspective view of an assembled structure, in this case a dwelling unit, after completed assembly according to the teachings of the present invention;

FIG. 8A is a sectional view showing attachment features of the PET panels according to the teachings of the present invention;

FIG. 8B is an exploded end view showing attachment features and process of the PET panels according to the teachings of the present invention;

FIG. 9 is a close-up cross-sectional view of various parts and construction/assembly process of a ceiling of a structure according to another embodiment of the present invention;

FIGS. 10A-10G are cross sectional views of various joints used to connect side walls of the dwelling unit according to embodiments of the invention.

FIG. 10A illustrates a cross-sectional view of non-splined corner joint with structural tape(s) at inside and outside corners, for use in attaching exterior walls.

FIG. 10B illustrates a splined corner joint with structural tape(s) at inside and outside corners, for use in attaching exterior walls.

FIG. 10C illustrates a non-splined miter joint with standard 45 degree cut and structural tape(s) at inside and outside corners, for use in attaching exterior walls.

FIG. 10D illustrates a non-splined miter joint made by cutting a standard 45 degree cut while leaving the exterior skin untouched, for use in attaching exterior walls.

FIG. 10E illustrates a non-splined radiused miter joint made by cutting a standard 45 degree cut while leaving the exterior skin untouched and removing a portion of the PET foam core at the exterior-facing edge, for use in attaching exterior walls.

FIG. 10F illustrates a splined, radiused miter joint with additional slots for attaching a structural spline within the joint, for use in attaching exterior walls.

FIG. 10G illustrates a splined linear butt joint with additional slots made by cutting a standard groove within the PET core at the exposed foam edge, for use in attaching exterior walls.

FIG. 11A is a cross-sectional view of splined panel edge conditions showing a weathertight covering comprised of various skin materials.

FIG. 11B is a cross-sectional view of panel edge conditions showing a weathertight covering comprised of various skin materials.

FIG. 12A is a top view of a wall assembly that allows for a space between panel assemblies that allow for utilities to be run inside the insulated cavity of the wall.

FIG. 12B is a perspective view of a wall assembly of FIG. 12A

FIG. 12C is a perspective view of a wall assembly of FIG. 12A with the panel assembled and showing the front, top, and left side.

FIG. 12D is a perspective view of a wall assembly of FIG. 12A with the panel assembled and showing the back, top, and right side.

FIG. 13A is a top view of a second embodiment of a wall assembly that allows for a space between panel assemblies that allow for utilities to be run inside the insulated cavity of the wall.

FIG. 13B is a perspective view of the second embodiment of a wall assembly of FIG. 13A.

FIG. 13C is a perspective view of the second embodiment of a wall assembly of FIG. 12A with the panel assembled and showing the front, top, and left side.

FIG. 13D is a perspective view of the second embodiment of a wall assembly of FIG. 12A with the panel assembled and showing the back, top, and right side

### DETAILED DESCRIPTION OF THE PREFERRED EMBODIMENTS

The present invention features systems and methods for constructing partially or fully prefabricated structures such as dwelling units, backyard structures (studios, studies and the like for example), commercial structures, pop-up restaurants and others.

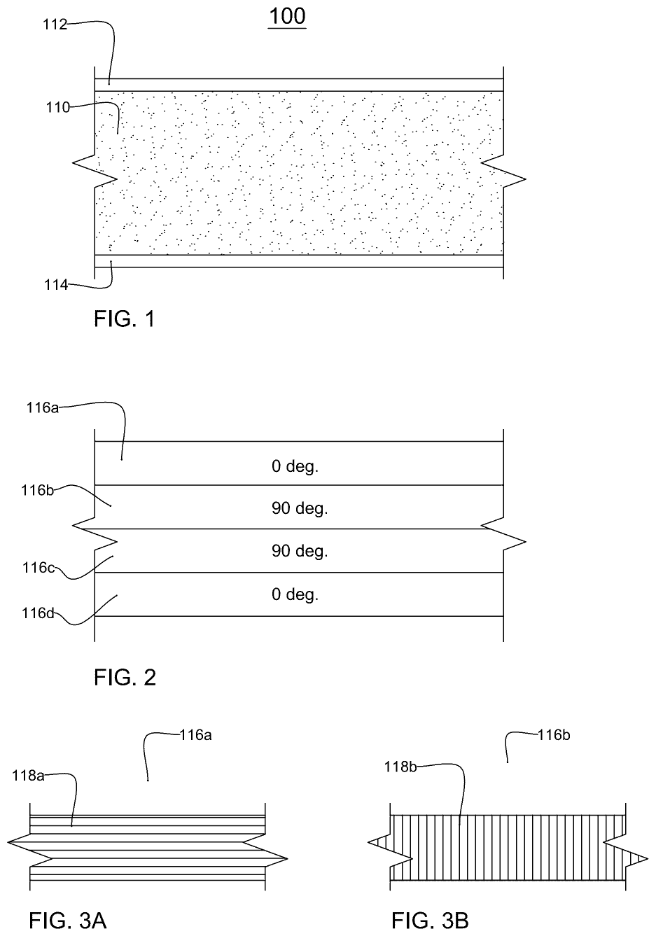

The present invention features and begins with a Polyethylene terephthalate (“PET”) construction panel 100, FIG. 1, manufactured from recycled plastic bottles and other PET plastic products. The panel includes a generally soft core, also referred to as a central core 110, of varying densities which can vary in thickness from ¼ inch and upwards. The core 110 typically provides an “R” insulation factor of 4 or more per inch of thickness and therefore a 5-inch core would provide a panel with an insulating factor of R20 or greater, depending upon core density.

The core 110 includes “skins”, a first skin 112, and a second skin 114, located on both the top and bottom layers of the core 110, the top and bottom layers being extended planar surfaces. Each skin 112, 114 may also made from recycled PET plastic and may be bonded to the core 110 using adhesives such as a PUR adhesive for example or the like, or heat bonded to the core 110. When using PET for the skins the entirety of the panel 100 may be recycled given that all elements are PET materials. However, the skins are not required to be made from PET materials, for example, they may also be comprised of wood, plywood, and/or metals such as aluminum sheets.

Both the top and bottom skins 112, 114 are of a multi-layered construction. In the preferred embodiment, each skin 112, 114, is a 4-layer construction, for example as shown in FIG. 2 as 116a, 116b, 116c, and 116d, although fewer or a greater number of layers are contemplated. For example, the construction may involve 2-ply PET skins. The skins 112 and 114 may also be PET layers manufactured and reinforced with fiberglass or similar strands oriented 90 degrees to one another in each adjacent layer. For example, skin layer 116a includes fiberglass or similar reinforcing strands 118a, FIG. 3A, oriented in one direction (shown horizontally for illustrative purposes) which is termed the 90-degree direction for explanation purposes. The next adjacent layer of the skin 116b, FIG. 3B, includes reinforcing strands 118b arranged 90 degrees from the direction of the strands 118a in adjacent layers 116a and 116c. In this manner of construction and reinforced fiber orientation, the skins provide rigidity to the panel 100. A typical skin layer thickness is contemplated within a range of 0.019 inches to approximately 0.080 inches although this is not a limitation of the invention.

The panels 100 can be manufactured in almost unlimited sizes and can be easily cut, shaped, drilled, routed or the like as desired. The panels are utilized to form the floor, walls, ceiling and/or roof of a structure, without need for any other structural elements or materials such as wooden or steel wall studs or floor or ceiling joints/rafters, although additional structural systems can be employed if desired. In addition, both the interior and exterior layers of the panels 100, the skins 112 and 114, may be painted or if desired, covered with siding, roofing, or other coverings. Because the panels are made of recycled PET, they are impervious to moisture and rot, as well as attack from insects.

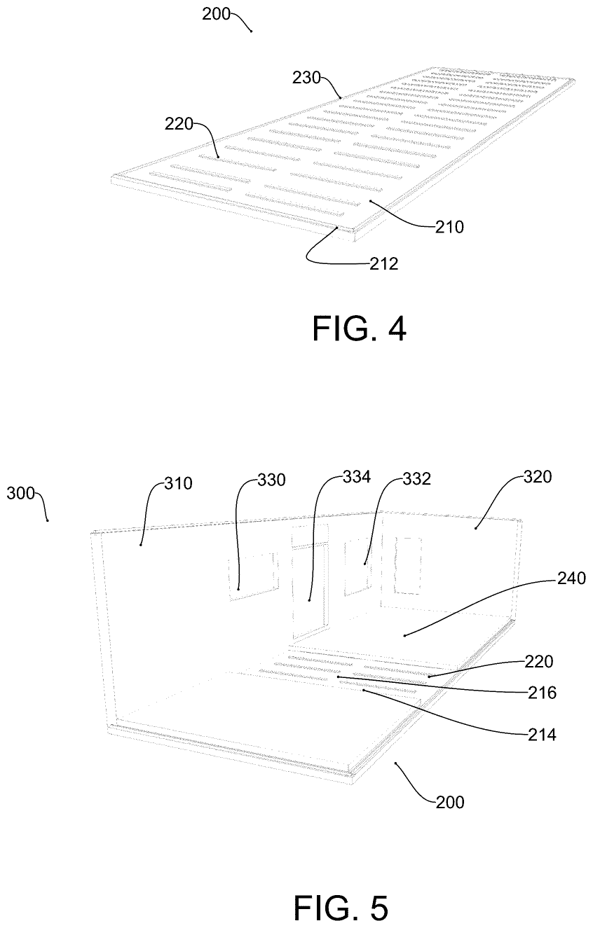

In one manufacturing process step, a subfloor 200, FIG. 4 is prepared. The subfloor 200 may be manufactured from one single panel or alternatively, multiple panels may be joined together to arrive at the desired size (length, width, or thickness) to form a full-sized subfloor 210. Once assembled to the appropriate size, the subfloor 210 is machined to create a “groove” or slot 212 around generally the entire perimeter of the subfloor to receive a spline around the perimeter of the subfloor. In some embodiments, slots may also be formed in the middle of the subfloor 210 area to receive splines 230 that connect interior walls or modules. The machined slots or grooves 212 are typically approximately ¾ inch wide by 1-inch deep, but additional spline and groove sizes are permissible. Once the slots 212 are formed, pre-cut splines 230 having a dimension of % inch by 3 inches are secured into the grooves 212 in the subfloor 210. The splines 230 are of the same construction described above with regard to the panels 100 (central core and skins of both sides), although only % inches in thickness. In some embodiments, an adhesive such as PVA glue, two-part epoxy, PUR glue, adhesive tapes, and/or other types of commercially available or proprietary adhesives are used to secure the splines 230 into the slots 212. In some embodiments, hardware fasteners such as screws, nails, or staples can be used to further secure the splines 230 to the subfloor 210.

In addition to splines 230, floor “sleepers” 220 made of the same PET material are installed onto the subfloor 210 to provide channels between the sleepers 220 under the floor 240, FIG. 4, through which utility (electrical and the like) can be installed. The splines 230 and sleepers 220 typically are cut from the same stock and differ only in length and/or width. The completed floor assembly 200 shown in FIG. 4 is then ready to be transported to a final assembly area or potentially assembled in a manufacturing facility.

FIG. 5 shows a partial structure 300. Wiring harness and rough plumbing 214, 216 may be installed between the sleepers 220 at locations predetermined during the pre-build phase. A first exterior wall 310 and second exterior wall 320, which is adjacent the first exterior wall 310, are then placed onto adjacent splines 230. Walls such as wall 310 may also include window and door openings, 330, 332 and 334, as desired. The bottom region of the walls 310, 320 also include grooves placed and shaped to interconnect with the splines 230 inserted in the floor 240. Any utility hookups to fixtures such as outlets, faucets, lighting, etc. may then be hooked up as needed prior to or after installation of the exterior walls on the splines 230. Alternatively, electrical outlets and the like may be located in the floor 240.

The exterior walls are joined to the splines 230 by adhesive and/or physical fasteners as described in more detail below. Finish flooring panel(s) 240 may be installed over a section of sleepers 220 and any utility runs placed therebetween. The flooring panel 240 is adhered to the sleepers 220 with adhesive and/or fasteners as described more fully below. Additional flooring panels 240 are installed onto other sleepers 220 such that open areas are provided for installation of module 420s during the third assembly process.

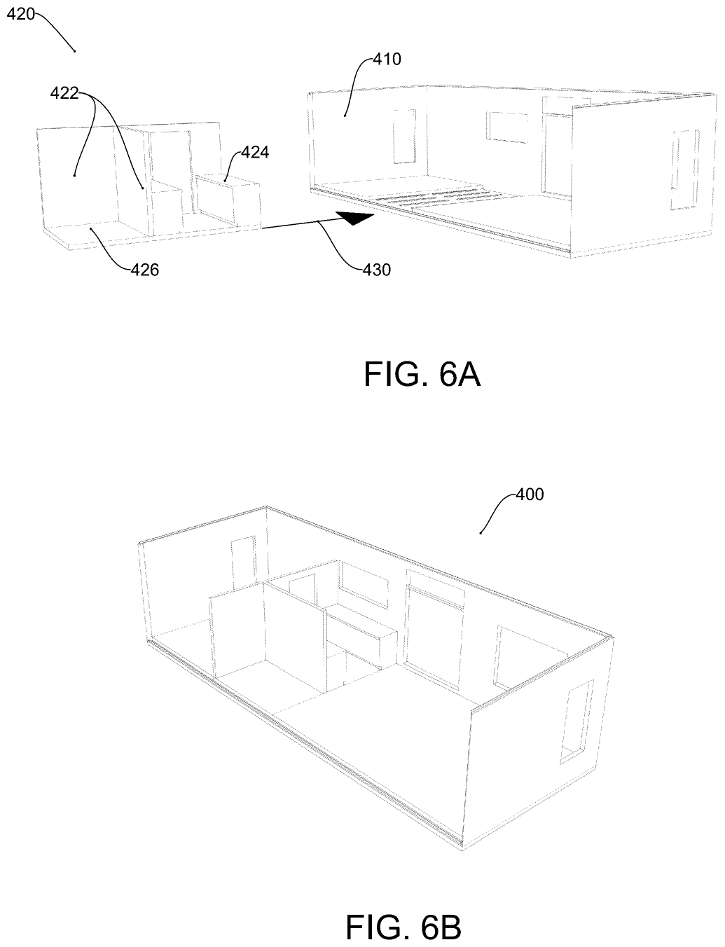

If a kitchen or bath is desired in the structure, it may be prebuilt as a unit 420, FIG. 6A and ultimately slid onto the assembled subfloor in the direction indicated generally by arrow 430 to a final position shown of a complete module 400 as shown in FIG. 6B. During the assembly process, the kitchen/bath module 420, including its associated wiring, plumbing and in some configurations cabinetry or built-in furniture 424 may be installed and a third exterior wall 410 installed, see FIGS. 6A and 6B. Module 420s may include finished flooring, such as carpet, linoleum, tile, wood or other floor types, and at least one interior wall 422 to provide a distinct location within an assembled structure. Module 420s can be any desired shape or size and can extend all the way from one edge of the subfloor 210 to an opposite edge or installed exterior wall at such edge or can extend over a smaller area above the subfloor 210 with space between the at least one interior wall of the module 420 and external walls.

In some embodiments, module 420 includes sleepers 220 preinstalled under the module 420 flooring to protect utility runs preinstalled under the flooring as well as to provide for added utilities for these modules such as added electrical and/or plumbing supplies. The module 420 flooring can in some embodiments be at a different height due to thicker sleepers 220 from the regular flooring to provide for larger utility runs, such as for wastewater pipes.

Module 420 can include kitchen module 420 which has the necessary hardware and features necessary for food preparation, such as sinks, appliance hookups, and countertops. In some embodiments, appliances themselves may be preinstalled and plumbed, such as dishwashers, refrigerators, ovens, microwaves, etc. Module 420 may also include a bathroom module 420 outfitted with the necessary features to function as bathroom, such as a toilet, shower, and sink. Modules 420 also include runs for electrical wires to provide light to the interior of the module 420. In some embodiments the module 420s also include utility runs that extends through the at least one interior wall to interface with a ceiling hookup. The utility runs can include wiring to power overhead lighting to other areas of the interior or exterior of the dwelling, as well as plumbing to provide fire sprinklers or other water features.

During the assembly process, exterior windows and doors are installed, interior trim work is completed, flooring, tiles, paint, cabinetry, and other fixtures are installed, utility hookups are terminated and connected to an exterior hookup and the roof & ceiling assemblies are installed.

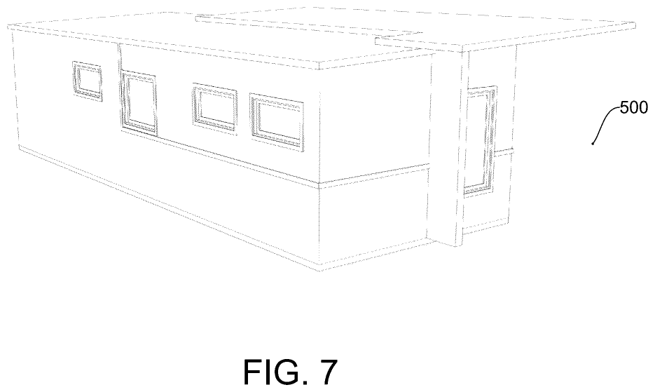

The structure is substantially completed 500, FIG. 7 during the next assembly process which may include one or more of interior and/or exterior painting, trim, weather sealing, etc. Any custom work may be completed. The structure may be assembled in a factory and shipped or assembled on site.

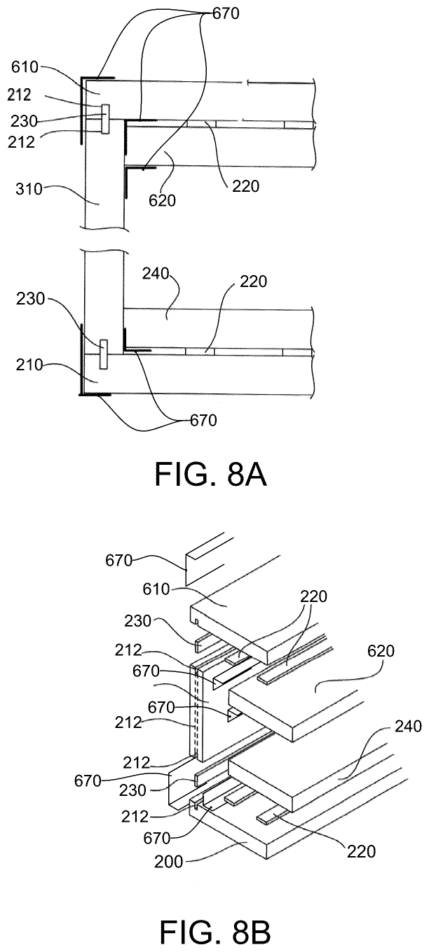

FIGS. 8A and 8B show a cutaway view and an exploded view, respectively, of a floor to exterior wall to roof connection. As mentioned above, the subfloor 200 includes slots that receive a spline 230, and sleepers 220 are installed onto the subfloor. An exterior wall 310 is placed onto the splines, utility runs (not shown) are installed, and flooring 240 is placed on top of the sleepers. Once any added modules are installed in the interior of the structure (such as kitchen and/or bath modules mentioned above), a roof 610 is installed onto the exterior walls 310 using splines 230 in wall slots and roof slots. In some embodiments, the roof may also have an insulated or uninsulated ceiling 620 and may include sleepers 220 that provide channels 630 between the roof panel 610 and a ceiling 620 such as insulated panels, sheetrock for example or the like, secured to sleepers 220 secured to the roof panel 610. The channels 630 provide space for utility runs to be laid out. The ceiling utility runs and ceiling 620 may be installed prior to installation of the roof onto the exterior walls.

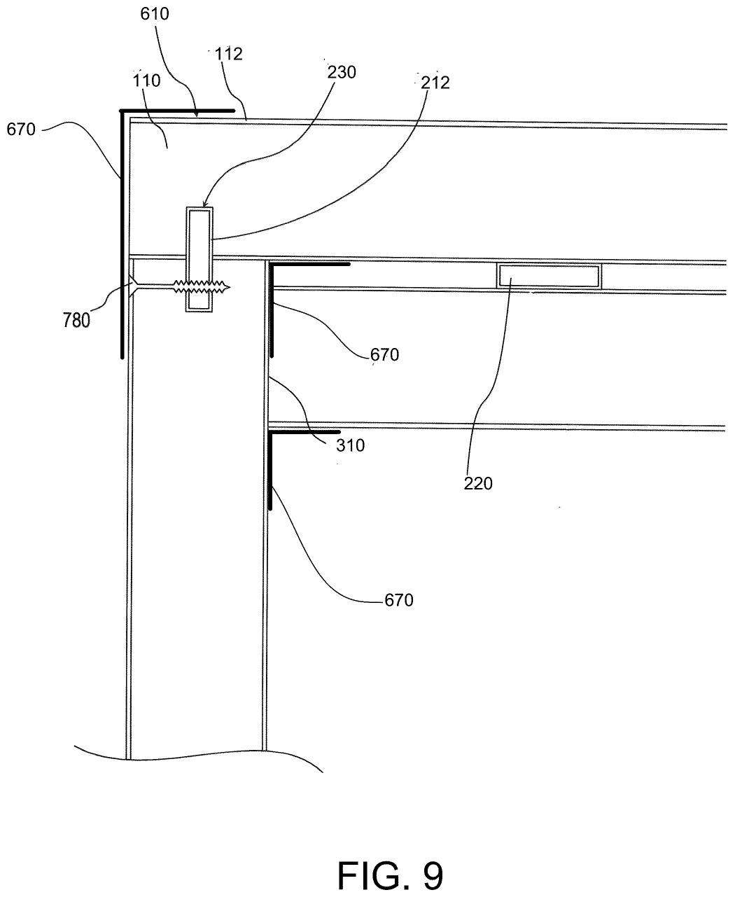

FIG. 9 shows a preferred panel type used for the walls, subfloor, ceiling, and/or roof, as well as for both the splines 230 and the sleepers 220. Panels are formed of a rigid foam core that is clad on both sides by a solid multi-layered skin. The rigid foam panel is preferably formed from a recycled PET structural insulation panel that provides strength, insulation, insect and environmental resistance properties. While strong in compression, insulation panels do not ordinarily provide significant tensile strength to withstand bending or pulling forces applied thereto. In order to provide additional strength and resistance to impact, weather, etc., the multilayered “skin” material is adhered or fastened to the insulation panel core. The composite sheet, in the preferred embodiment, is formed of the same recycled PET material as the insulation panel. This provides for greater compatibility for adhesives used to join the materials, as well as providing the same or very similar expansion and contraction characteristics that the materials undergo as temperatures change. This feature acts to add additional durability and stability compared with structures utilizing different building materials.

The splines and sleepers of FIG. 9 are shown with cladding extending around at least the two wider surfaces of the splines 220 or alternatively around the entire exterior surface of the spline material. This provides additional strength as essentially a tube beam, in addition to the strength of the structural insulation within the cladding. In some other embodiments, splines can be cut from the panels that make up the walls and floor. In other embodiments the splines and sleepers are ripped from a thinner panel material, with the end result providing cladding on the two wider surfaces of the spline 220. The splines 220 may be installed using adhesive with or without screw type fasteners 780 which hold the panels together by virtue of the fact that the screws 780 penetrate the front and rear skins on the spline 220.

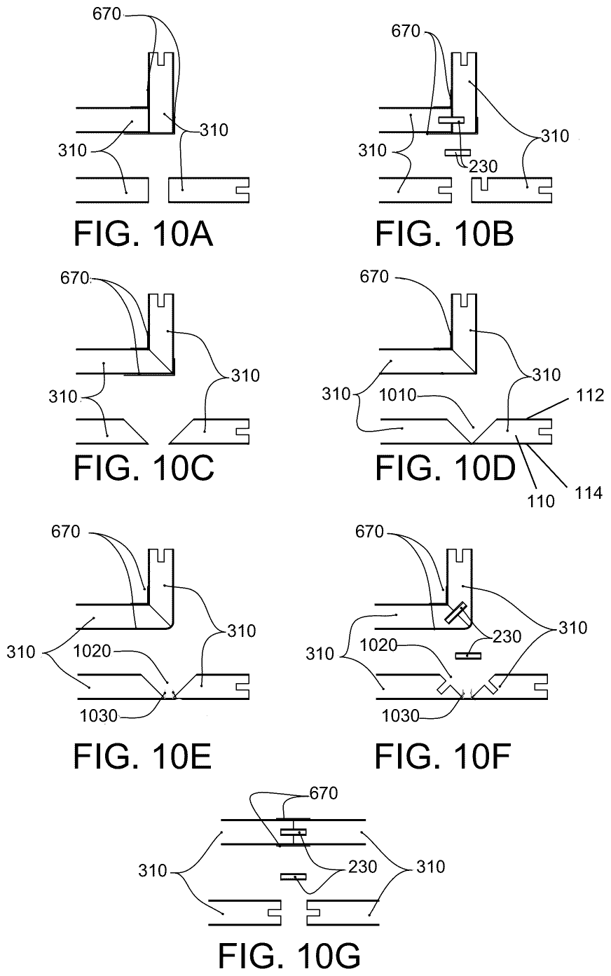

In different embodiments, exterior walls 310 may be attached to one another to form a corner assembly. Here again, each wall is panel comprising a first skin 112, a second skin 114, and core 110. For example the corner is formed from a butt-joint as shown in FIG. 10A, or a splined butt joint as shown in FIG. 10B. A miter joint of FIG. 10C includes, for example, a basic standard 45 degree cut in each exterior wall that are adhered and/or fastened to one another as described herein. In FIG. 10D, the non-splined miter joint of FIG. 10D is made by cutting a standard 45 degree cut 1010 through the first skin 112 and the core 110, while leaving the second skin 114, the “exterior skin” untouched. The corner assembly is then folded so that the exterior skin is intact over the entire length of the corner joint, with structural tape(s) 670 at inside corner. This structure allows for a stronger, completely weather tight corner, as the pieces remain connected by the exterior skin while also being held together with adhesives and/or fasteners.

The non-splined radiused miter joint of FIG. 10E is made by cutting a standard 45 degree cut 1020 while leaving the exterior skin untouched and removing a portion of the PET foam core at the exterior-facing edge 1030. The corner assembly is then folded so that the exterior skin is intact over the entire length of the radiused corner joint, with structural tape(s) 670 at inside corner. The joint includes the channel described in connection with FIG. 10D, but adds an additional cut 1030 that is substantially perpendicular to the remaining skin adjacent the corner of the slot. Again, folding the corner assembly so that the exterior skin is intact over the entire length of the corner joint, with structural tape(s) 670 at inside corner, creates a “folded skin” that allows for a stronger, completely weather tight corner, as the pieces remain connected by the exterior skin while also being held together with adhesives and/or fasteners.

FIG. 10F illustrates a splined, radiused miter joint with additional slots for attaching a structural spline 230 within the joint, made by cutting a standard 45 degree cut 1020 while leaving the exterior skin untouched and removing a portion of the PET foam core at the exterior-facing edge 1030. The spline 230 is adhered inside one slot and the corner assembly is then folded so that the exterior skin is intact over the entire length of the radiused corner joint and the exposed remaining half of the spline is adhered in the opposing slot, with structural tape(s) 670 at inside corner, for use in attaching exterior walls. The joint of FIG. 10F adds slots 212 in the joint cut 1020 and a spline 230 to the mitered joint to add additional surfaces for adhesives, as well as additional layers of cladding. Again, folding the corner assembly so that the exterior skin is intact over the entire length of the corner joint, with structural tape(s) 670 at inside corner, creates a “folded skin” that allows for a stronger, completely weather tight corner, as the pieces remain connected by the exterior skin while also being held together with adhesives and/or fasteners.

FIG. 10G illustrates a splined linear butt joint with additional slots made by cutting a standard groove within the PET core at the exposed foam edge. The butt joint assembly is then pulled together to be weather tight, so that the exterior skins of both panels make full contact over the entire length of the joint, with adhesive within the joint, surrounding the spline and structural tape(s) 670 at inside and outside faces, for use in attaching exterior walls.

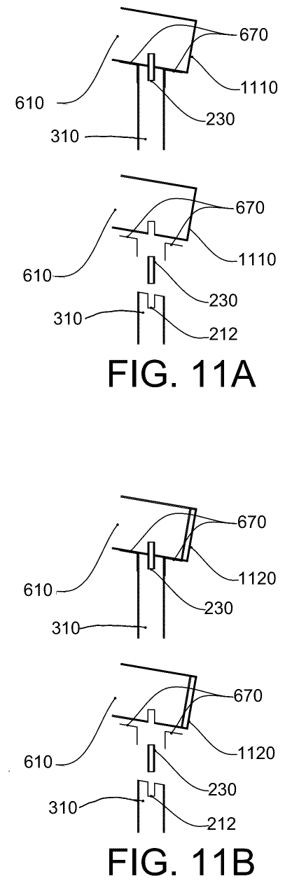

FIGS. 11A and 11B illustrate a roof/wall assembly cross section. The section shows a roof overhang, past the outside surface of the wall. The roof can be any thickness and the overhang can be of varying depths. The splined joint assembly is similar to those mentioned in FIGS. 10a-10F.

FIG. 11A illustrates the roof 610/wall 310 assembly with a thin layer edge banding 1110 at the roof panel 610 edge. This edge band skin can be of PET, similar to the typical PET skins 112, 114 mentioned previously. Edge band 1110 can also be made of other thin materials such as sheet metal, other composites or wood veneer. Edge bands are to be laminated to the edge of the roof panel 610 core prior to exterior and interior skin laminations to the core for a permanent, weather tight seal.

FIG. 11B illustrates the roof 610/wall 310 assembly with a thick (0.5″-1.5″+/−) layer edge band panel 1120 at the roof panel 610 edge. This edge band panel can be of PET panels as described herein. Edge band panel 1120 can also be made of other solid or composite materials such as sheet metal panel, PVC, other composites or wood. Edge band panels are to be laminated to the edge of the roof panel 610 core prior to exterior and interior skin laminations to the core for a permanent, weather tight seal.

The joints disclosed herein are bonded with adhesives such as PUR glue or the like to secure the splines 230 into the slots 212.

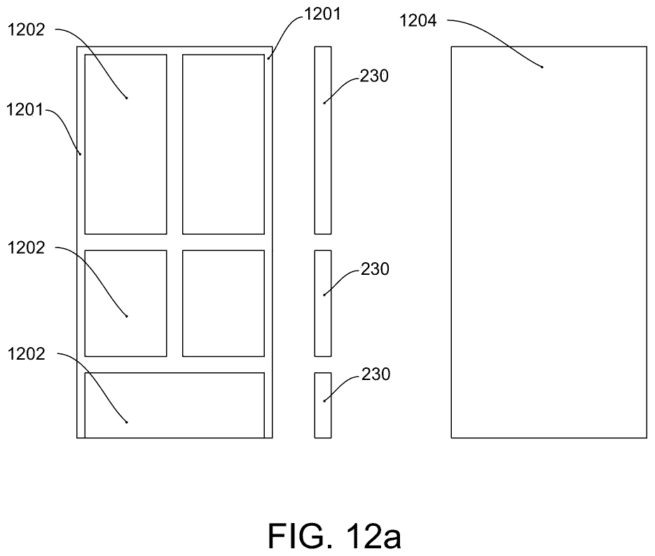

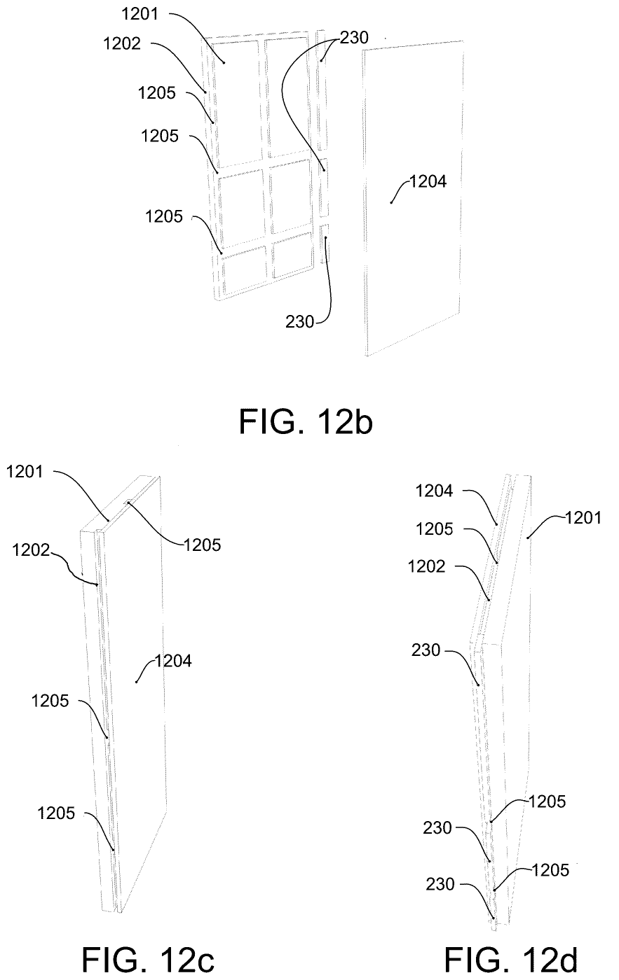

FIGS. 12a-12d illustrate a wall assembly that allows for a space between panel assemblies that allow for utilities to be run inside the insulated cavity of the wall, which is referred to as a “Space Panel”. This wall assembly is made by SUBTRACTING material from the thicker, exterior foam core of the single-sided exterior part of the panel.

Channel 1201 is routed out of the overall base panel, with the channel have a depth between approximately 0.75″-1″. Remaining sections 1202 of the base panel maintain full thickness. The bottoms of the panels are kept solid to prevent water infiltration. Splines 230 are used to join one panel to another panel, and are parted to allow utilities to pass horizontally and vertically between panels, with the exception of the bottoms, which remain solid to prevent water infiltration. The splines 230 form the “tongue” of a “tongue & groove” joint. The spacers on the other edge of the adjoining panels form the groove.

Panel 1204 forms the interior face of wall. A single-skinned panel assembly that encapsulates the channels & forms the interior finished surface of the wall panel. Channel 1205, shown in FIGS. 12b-d, is left by the routed material itself and is where the utilities might run. This system may be used for roofs and floors as well.

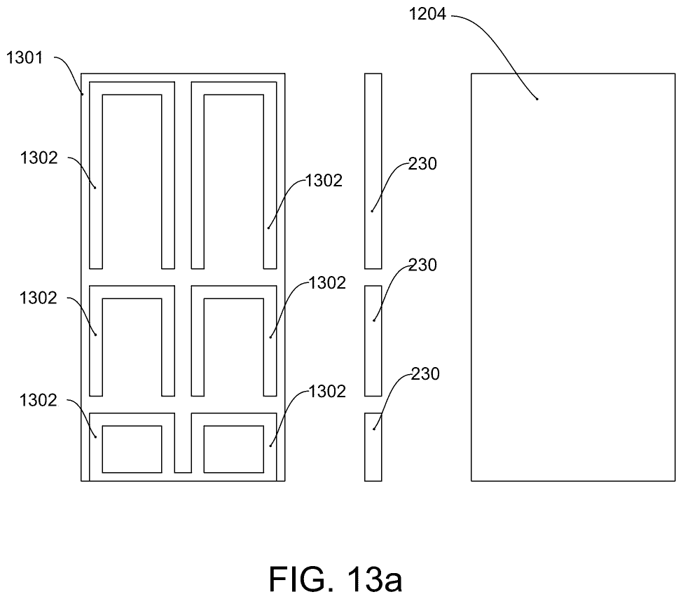

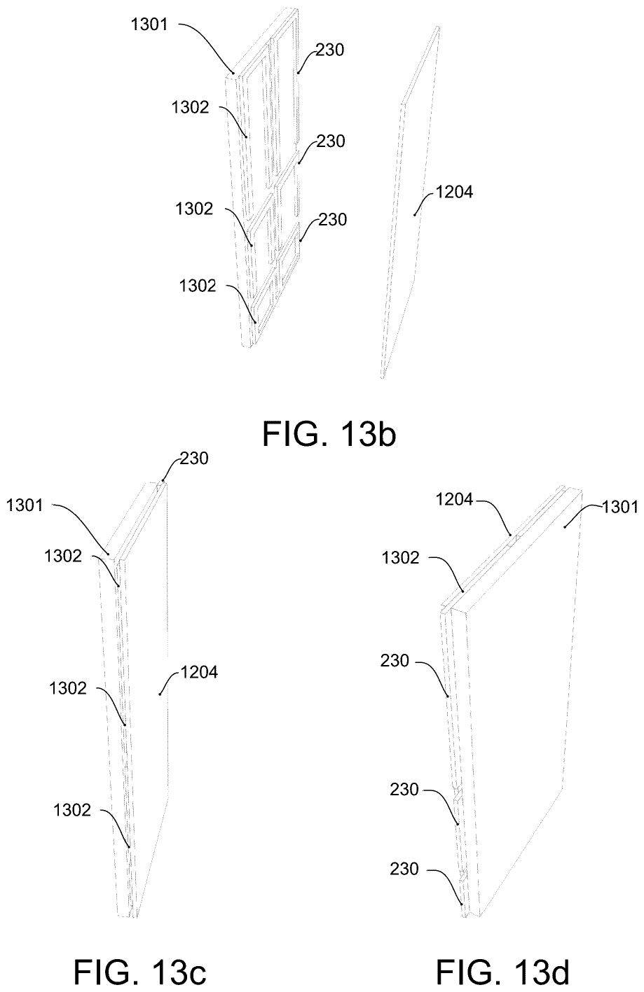

FIGS. 13a-13d are views of second embodiment of the Space Wall assembly that allows for a space between panel assemblies that allow for utilities to be run inside the insulated cavity of the wall. This second embodiment is made by ADDING material onto the thicker, exterior foam core of the single-sided exterior part of the panel, for example, by adhering strips of our ¾″ panel or foam cores in a set pattern to form the channels mentioned in the FIG. 12 paragraph above.

In this embodiment, the base panel 1301 remains full thickness. Panel strips 1302 are added onto the face of 1301 in the pattern shown. Other patterns may be used as well. These strips add to the overall thickness of the base panel and provide an additional layer of insulation via an air gap. The strips are typically pieces of ¾″ panel, but can be of PET foam of various densities, similar to the core, or wood, metal or other composites.

Splines 230, are used to join panel to panel, splines are strips of ¾″ panel material, which are parted to allow utilities to pass horizontally and vertically between panels, with an exception for the bottoms, which remain solid to prevent water infiltration. The splines 230 form the “tongue” of a “tongue & groove” joint. The spacers on the other edge of the adjoining panels form the groove.

Panel 1204 forms the interior face of wall, and is a single-skinned panel assembly that encapsulates the channels & forms the interior finished surface of the wall panel. This system may be used for roofs and floors.

In some embodiments the adhesives may be fortified with various fibers to add tensile strength to the cured adhesive. The fibers can be carbon fiber, fiberglass, Kevlar(R), or other material exhibiting high tensile strength. In some embodiments, hardware fasteners such as screws, nails, or staples can be used to secure a joint or other item to the panel material. The rigid skin material aids the strength of such fasteners, increasing their holding ability and resistance to pulling out of the panel.

It is important to note that the present invention is not intended to be limited to a device or method which must satisfy one or more of any stated or implied objects, embodiments or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by any allowed claims which may flow from this application and their equivalents.

The invention claimed is:

1. A construction panel comprising:
a central core region manufactured from recycled PET plastic material, said central core region including first and second extended planar surfaces;
a first skin disposed against said central core region first extended planar surface; and
a second skin disposed against said central core region second extended planar surface.

2. The panel of claim 1 wherein said first and second skins are adhered to said first and second planar surfaces of said central core region respectively.

3. The panel of claim 1, wherein the first skin is comprised of multiple layers.

4. The panel of claim 3, wherein the second skin is comprised of multiple layers.

5. The panel of claim 4, wherein the first skin and the second skin each include fiber reinforced PET plastic material where said fibers are oriented generally in a single direction.

6. The panel of claim 4, wherein the first skin and the second skin include fiber reinforced PET plastic material where said fibers oriented 90 degrees with respect to at least one adjacent layer.

7. A method of constructing a structure using the panel of claim 1, comprising the acts of:
providing a plurality of panels;
routing a slot proximate one or more edges of said plurality of panels;
providing one or more splines configured for engaging with said routed slot in one or more edges of said plurality of panels;
assembling two of said panels together by inserting and adhering said one or more spline in one routed slot of one panel and inserting a slot from a second panel over said spline; and
wherein said panels are configured to serve as one or more of marine components, walls, floors, ceilings and roofs of said structure.
